(19) United States
(12) Patent Application Publication
(10) Pub. No.: US 2016/0043909 A1
(43) Pub. Date: Feb. 11, 2016

(54) Hierarchical Subscription Management

(71) Applicant: MICROSOFT CORPORATION, Redmond, WA (US)

(72) Inventors: Vladimir Pogrebinsky, Redmond, WA (US); Sata Busayarat, Redmond, WA (US); Jameel A. Gbajabiamila, Seattle, WA (US)

(73) Assignee: MICROSOFT CORPORATION, Redmond, WA (US)

(21) Appl. No.: 14/455,791

(22) Filed: Aug. 8, 2014

(51) Int. Cl. H04L 12/24; G06Q 20/10; H04L 29/08

(52) U.S. Cl. CPC H04L 41/50; H04L 67/10; G06Q 20/102

(57) ABSTRACT

Embodiments of the invention provide a subscription management service that allows an organization create unique offers, plans, and subscriptions. The resources are created under organizational subscriptions in a hierarchical manner. Each subscriber is a sub-organization of the level above it and can independently manage its services. Administrators for each subscriber at each level can define their sub-organizations. Each subscriber can install their own organizational services as long as those services are supported by the subscription. Subscribers may create their own organizational plans, such as defining how services are packaged and offered to other sub-organizations and end users. For example, a reseller may create service packages at different price levels and offer those to tenants. Administrators may create organizational subscriptions that are managed by subscribers.

### BACKGROUND

Cloud computing enables ubiquitous, on-demand network access to a shared pool of configurable computing resources that can be rapidly provisioned and released with minimal management effort or service provider interaction. The resources may include, for example, processing, servers, storage, applications, network bandwidth, and services. A typical cloud model provides on-demand self-service, broad network access, resource pooling, rapid elasticity and measured service. Cloud consumers unilaterally provision computing capabilities as needed without requiring service provider interaction. The cloud services are available over public and/or private networks and are accessed using standard mechanisms. The cloud provider's computing resources are pooled so that they can be used to serve multiple consumers by dynamically assigning and reassigning physical and virtual resources according to consumer demand (i.e., multi-tenant).

The cloud consumer generally has no control or knowledge over the location of the provided resources which may be supported by one or more distributed datacenters. The cloud services are elastically provisioned and released to allow for rapid scaling with demand. As a result, the capabilities may appear to the consumer as unlimited and available for provisioning in any quantity at any time. Cloud systems automatically control and optimize resource use by leveraging a metering capability appropriate to the type of service.

Existing cloud systems offer a global plan to subscribers so that the same services, theming, usage collection, and billing are applied to all subscribers.

A datacenter or distributed computer system may be used to provide cloud services to subscribers. Advantageously, a provider configures the datacenter by subscribing to a zero-day plan that provides a predetermined set of services and resources on the datacenter. The provider may then create one or more organization and/or reseller plans for other entities. An organization subscribes to a selected organization plan, which provides a set of services. Advantageously, the organization creates plans that are offered to sub-organizations for subscription. A reseller may subscribe to a reseller plan. Advantageously, the reseller may offer plans for resale to tenants.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the invention provide a subscription management service that allows an organization create unique offers, plans, and subscriptions. The resources are created under organizational subscriptions in a hierarchical manner. Each subscriber is a sub-organization of the level above it and can independently manage its services. Administrators for each subscriber at each level can define their sub-organizations. Each subscriber can install their own organizational services as long as those services are supported by the subscription. Subscribers may create their own organizational plans, such as defining how services are packaged and offered to other sub-organizations and end users. For example, a reseller may create service packages at different price levels and offer those to tenants. Administrators may create organizational subscriptions that are managed by subscribers.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high level block diagram of a system that provides enterprise users with access to local, on-premises resources and to remote or public resources.

FIG. 2 is a block diagram of a datacenter that provides cloud computing services or distributed computing services according to one embodiment.

FIG. 3 illustrates a subscription management hierarchy according to one embodiment.

FIG. 4 is a flowchart illustrating a method of providing hierarchical subscription services in one embodiment.

FIG. 5 is a flowchart illustrating a method for providing reseller plans according to one embodiment.

FIG. 6 a flowchart illustrating a method for offering reseller plans according to one embodiment.

### DETAILED DESCRIPTION

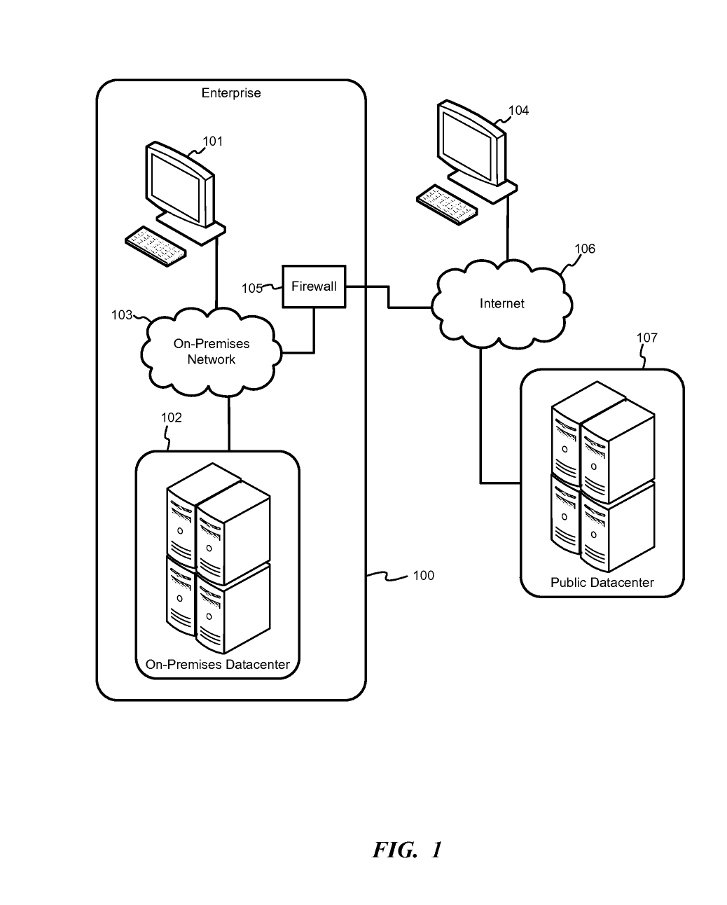

FIG. 1 is a high level block diagram of a system that provides enterprise users with access to local, on-premises resources and to remote or public resources. Local enterprise terminal 101 allows users to directly access on-premises datacenter 102 via on-premises network 103. Users located outside enterprise 100 may access on-premises datacenter 102 using remote terminal 104. Terminals 101 and 104 may be, for example, a desktop, laptop, notebook, or tablet computer. Other devices, such as dedicated terminals, smartphones, personal digital assistants (PDA), etc. may also be used as terminals 101 and 104.

Firewall 105 provides network security system for enterprise 100 and controls incoming and outgoing network traffic. External terminal 104 may connect to enterprise on-premises network 103 via Internet 106 or any public or private network. Firewall 105 allows terminal 104 to access on-premises datacenter 102 if terminal 104 provides the appropriate credentials and authentication. Enterprise users at terminals 101 and 104 may also access public datacenter 107 via Internet 106.

On-premises datacenter 102 and public datacenter 107 may provide “cloud computing” services to enterprise 100 and other users. By freeing enterprise users from managing information technology (IT) infrastructure, cloud computing provides virtually limitless compute, storage, and network resources at low cost, while allowing services to scale on demand.

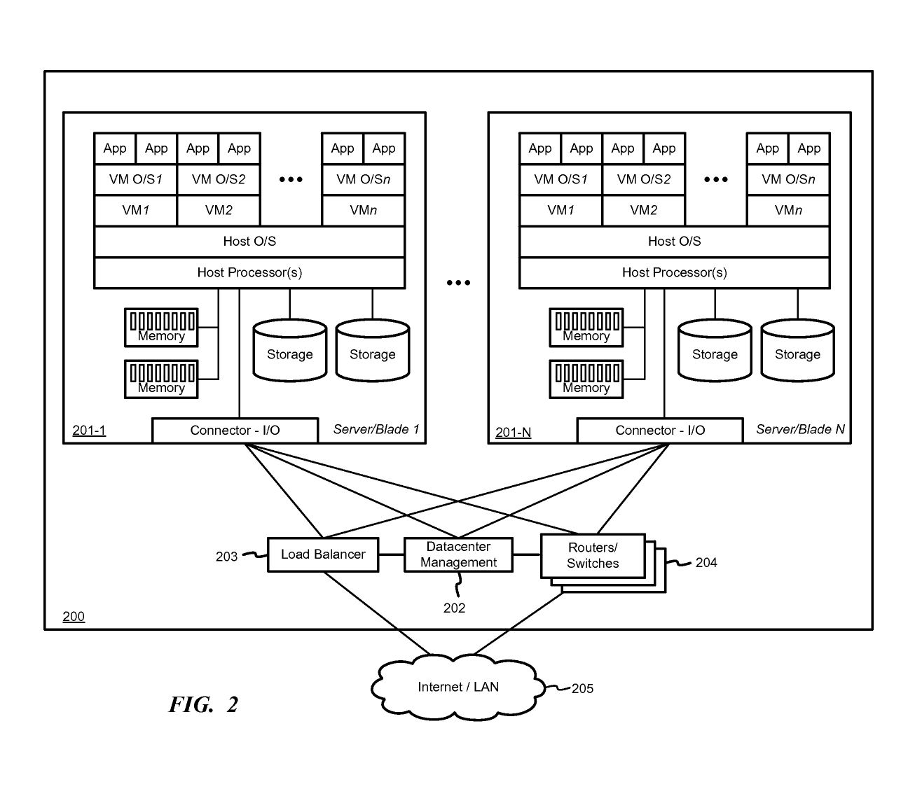

FIG. 2 is a block diagram of a datacenter 200 that provides cloud computing services or distributed computing services according to one embodiment. A plurality of servers 201 are managed by datacenter management controller 202. Load balancer 203 distributes requests and workloads over servers 201 to avoid a situation where a single server 201 becomes overwhelmed and to maximize available capacity and performance of the resources in datacenter 200. Routers/switches 204 support data traffic between servers 201 and between datacenter 200 and external resources and users via external network 205, which may be a local area network (LAN) in the case of an enterprise, on-premises datacenter 102 or the Internet in the case of a public datacenter (107).

Servers 201 may be traditional standalone computing devices and/or they may be configured as individual blades in a rack of many server devices. Servers 201 have an input/output (I/O) connector that manages communication with other database entities. One or more host processors on each server 201 run a host operating system (O/S) that supports multiple virtual machines (VM). Each VM may run its own O/S so that each VM O/S on a server is different, or the same, or a mix of both. The VM O/S's may be, for example, different versions of the same O/S (e.g., different VMs running different current and legacy versions of the Windows® operating system). In addition, or alternatively, the VM O/S's may be provided by different manufacturers (e.g., some VMs running the Windows® operating system, while others VMs run the Linux® operating system). Each VM may then run one or more applications (App). Each server also includes storage (e.g., hard disk drives (HDD)) and memory (e.g., RAM) that can be accessed and used by the host processors and VMs.

Cloud computing is the delivery of computing capabilities as a service, making access to IT resources like compute power, networking and storage as available as water from a faucet. As with any utility, you generally only pay for what you use with cloud computing. By tapping into cloud services, you can harness the power of massive data centers without having to build, manage or maintain costly, complex IT building blocks. With the cloud, much of the complexity of IT is abstracted away, letting you focus just on the infrastructure, data and application development that really matter to your business.

Datacenter 200 provides pooled resources on which customers or tenants can dynamically provision and scale applications as needed without having to add more servers or additional networking. This allows tenants to obtain the computing resources they need without having to procure, provision, and manage infrastructure on a per-application, ad-hoc basis. A cloud computing datacenter 200 allows tenants to scale up or scale down resources dynamically to meet the current needs of their business. Additionally, a datacenter operator can provide usage-based services to tenants so that they pay for only the resources they use, when they need to use them. For example, a tenant may initially use one VM on server 201-1 to run their applications. When demand increases, the datacenter may activate additional VMs on the same server and/or on a new server 201-N as needed. These additional VMs can be deactivated if demand later drops.

Datacenter 200 may offer guaranteed availability, disaster recovery, and back-up services. For example, the datacenter may designate one VM on server 201-1 as the primary location for the tenant's application and may activate a second VM on the same or different server as a standby or back-up in case the first VM or server 201-1 fails. Database manager 202 automatically shifts incoming user requests from the primary VM to the back-up VM without requiring tenant intervention. Although datacenter 200 is illustrated as a single location, it will be understood that servers 201 may be distributed to multiple locations across the globe to provide additional redundancy and disaster recovery capabilities.

The datacenter operator may offer different levels of cloud computing services to tenants. With an Infrastructure-as-a-Service (IaaS) offering, the lower levels of the IT stack are delivered as a service, which frees up developers from much of the complexity of provisioning physical machines and configuring networks. With IaaS, tenants can easily provision virtual machines in a highly scalable and available cloud environment, develop and test solutions, then deploy applications to production. With a Platform-as-a-Service (PaaS) offering, everything from network connectivity through the runtime is provided. PaaS makes development easy by providing additional support for application services and management of the operating system, including updates. With PaaS, tenants can focus on the business logic of application and quickly move applications from concept to launch. With a Software-as-a-service (SaaS) offering, a single finished application or suite of applications can be delivered to customers through a web browser, thereby eliminating their need to manage the underlying components of the IT stack including application code.

Referring again to FIG. 1, an enterprise may use a public datacenter or public cloud computing services to take advantage of cost savings, reduced management requirements, or particular services offered. On the other hand, the enterprise may also use an on-premises datacenter or private cloud services to ensure data security or to use a proprietary application, for example. It will be understood that an enterprise does not have to use an on-premises datacenter to take advantage of private cloud services. Instead, private cloud services may be provided by a datacenter that limits access to the enterprise. The use of both public cloud services and private cloud services by an enterprise is referred to generally as a hybrid cloud.

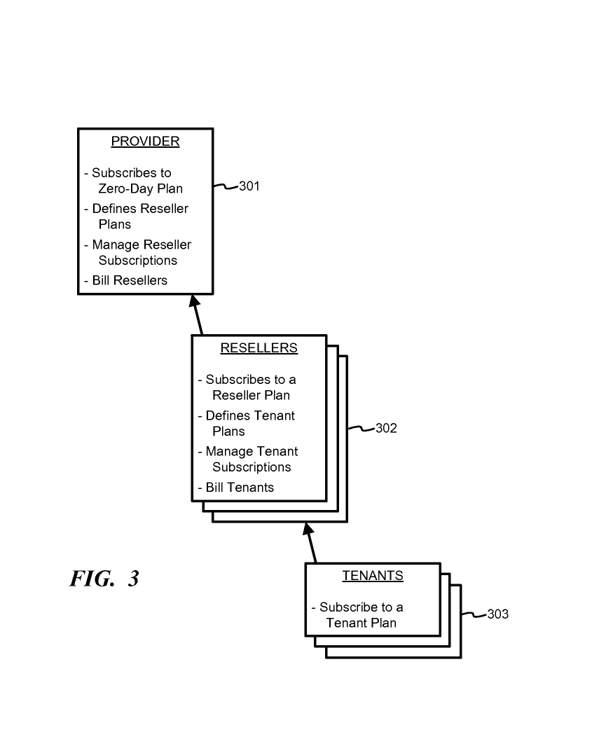

FIG. 3 illustrates a subscription management hierarchy according to one embodiment. Provider 301 is the datacenter or cloud service administrator. The provider subscribes to a zero-day plan that provides an initial set of services and resources on the datacenter or cloud service for the provider to use. The provider may define one or more reseller plans for use by cloud service resellers 302. These reseller plans provide various configurations of services, resources, security, authentication, fee structures, etc. that are available from the datacenter or cloud service from the provider 301.

Provider 301 manages the reseller subscriptions to the various reseller plans. Provider 301 also tracks the resellers' use of the datacenter services and resources and bills the resellers 302 accordingly.

Resellers 302 subscribe to a selected reseller plan offered by provider 301. Each reseller 302 defines one or more tenant plans that are offered to tenants 303, who are the end users of the datacenter services and resources. Like the reseller plans, the tenant plans provide various configurations of services, resources, security, authentication, fee structures, etc. that are available from the datacenter or cloud service to the end users. Resellers 302 manage the tenant subscriptions and track the tenants' use of the datacenter services and resources for billing.

Tenants 303 subscribe to one of the tenant plans offered by resellers 302 to obtain access to desired services and resources in the datacenter. Although the term “reseller” is used for an intermediate organization in FIG. 3, it will be understood that the administrator at this level does not have to be a commercial enterprise. For example, the reseller 302 may correspond to an enterprise IT department that provides subscriptions to various tenant 303 organizations or departments within the enterprise. The enterprise IT department may offer different datacenter subscriptions to different departments depending upon the type of services and resources required. Alternatively, the reseller 302 may also be a service provider that provides datacenter and cloud services to unrelated tenants 303.

The plans created by the provider 301 or reseller 302 may provide different combinations of services and resources. Additionally, different plan offerings may include different Service Level Agreements (SLA), different quotas, different capabilities to resell, etc.

The datacenter or cloud service management (i.e., subscriptions and resources) may be subdivided in a hierarchical manner. Each subscriber is a sub-organization of the level above it and can independently manage its services. Administrators for each subscriber at each level can define their sub-organizations. Each subscriber can install their own organizational services as long as those services are supported by the subscription. Subscribers may create their own organizational plans, such as defining how services are packaged and offered to other sub-organizations and end users. For example, a reseller may create service packages at different price levels and offer those to tenants. Administrators may create organizational subscriptions that are managed by subscribers.

The subscribers may apply their own theming to a subscription, such as logos, color schemes, and user interface elements that are exposed to sub-organizations and end users. Each sub-organization may provide and access a gallery or marketplace of applications and services that can be installed. For billing purposes, each organization may collect usage data from the sub-organizations.

A provider and/or organization may also assign Domain Name System (DNS) names to portals that provide the user experience for organizations and tenants. The provider and/or organization may also expose a management API to provide programmatic access for managing datacenter or cloud service resources.

Each organization may also manage which datacenter or cloud services a subscriber may access or attach. Additional features, such as the identity providers used by subscribers may be controlled by the organization to control where subscriber identities are defined.

All administrative functionality is provided under a hierarchical subscription context as opposed to a global context that has a single administrator. Subscription management is provided by a dedicated service that provides both tenant and administrator experience as opposed to separate administrator and tenant portals.

The subscription management service allows an organization create unique offers, plans, subscriptions, etc. Instead of being limited to a global set of resources, the resources are created under organizational subscriptions.

An organization may become a reseller of services and resources offered by a provider by repackaging those services and resources into customized subscriptions. Organizational tenants (i.e., members of an organization) can subscribe to organizational offers and organizational datacenter plans. Role-based access control is used to access the organizational plans and offers. Organizational offers and plans are secured so that they are accessible only to members of the organization. All offers are now organizational. When a subscription is created for an organizational offer, the subscription is associated with the same organization as the offer it is created against.

To create organizational plans, an organizational admin needs to specify the services and quotas to include in the plan. A service can appear in the organization plan, for example, either if the service was given to organization admin by the parent organization (i.e., a provider) for re-offering (i.e., reselling) or if the organizational admin installed his own services and the corresponding resource providers for managing the services.

Admins are able to create a plan and add a “Subscription Management” service into the plan. Only an administrator of a service can add a service to a plan. While creating the plan, the admin further configures “quotas” for “Subscription Management” service. Additionally, the service admin further configures constraints and features offered in the plan. Once a plan with “Subscription Management” service is created, it is possible to create subscriptions against that plan (i.e., a provider may offer the plan to resellers, and/or a reseller may offer the plan to tenants). Any subscription for a plan including the “Subscription Management” service automatically becomes an “Organizational” subscription. The admin for the organization can then create organizational resources such as plan, offer, subscription, etc. for that plan.

Installing services. Tenants of the subscription management service may register services. This allows an organization admin to install services on the datacenter and to register their resource providers (i.e., management service) with the organization. Hence, in this model, all services are treated as “organizational” services. Once a service is registered, such as by providing service endpoints, service namespace, region, etc, the service can be added into a new plan.

Reselling plans. Another way of offering services to tenants or sub-organizations is to “re-offer” services from a parent organization. When a parent organization creates an organization management plan, it adds the subscription management service to the plan. As part of configuring the subscription management service, the parent admin specifies which plans can be “re-offered” and how many times (i.e., quota). An organization admin who subscribes to such a plan is then authorized to “re-offer” the services specified in the quota configuration of the subscription management service.

Re-offered plans include service providers that are registered in the parent organization. Therefore, these re-offered plan services are different from any locally registered services (e.g., different services or different regions). Using this distinction, it is easy to attribute usage to the correct organization. Two different kinds of usage may be reported. First, a usage data stream generated by services included into a tenant plan is reported by service resource providers, associated with the tenant subscription, and exposed by a usage collector to the organizational admin. This is typically for billing purposes. Second, usage may be reported by the subscription management service regarding “re-offered” services. These reoffered services are associated with an organizational subscription and reported to organization that provided services for “re-offering”.

Once the organization concept has been established, it may be used for a range of other organizational scenarios, such as theming, gallery/marketplace, usage collection, billing, and DNS names for portal providing the user experience and management API providing programmatic access for managing cloud resources.

Zero-day plan. The zero-day plan applies to the provider or originally installing parent admin. Since there is no subscription existing for the provider when the provider admin sets up the datacenter service, the zero-day plan is used to define what services and resources are available to the provider.

Self-plan. When a new organizational subscription is created by an organization tenant, the subscription is associated with a special self-plan. This plan automatically includes all of the services registered in the organization. In this way, when an organization admin installs new services for the organization, those services automatically become available in the organizational subscription.

The usage subsystem determines that these services are not provided by a parent organization and, therefore, use flow remains within the organization that has services registered.

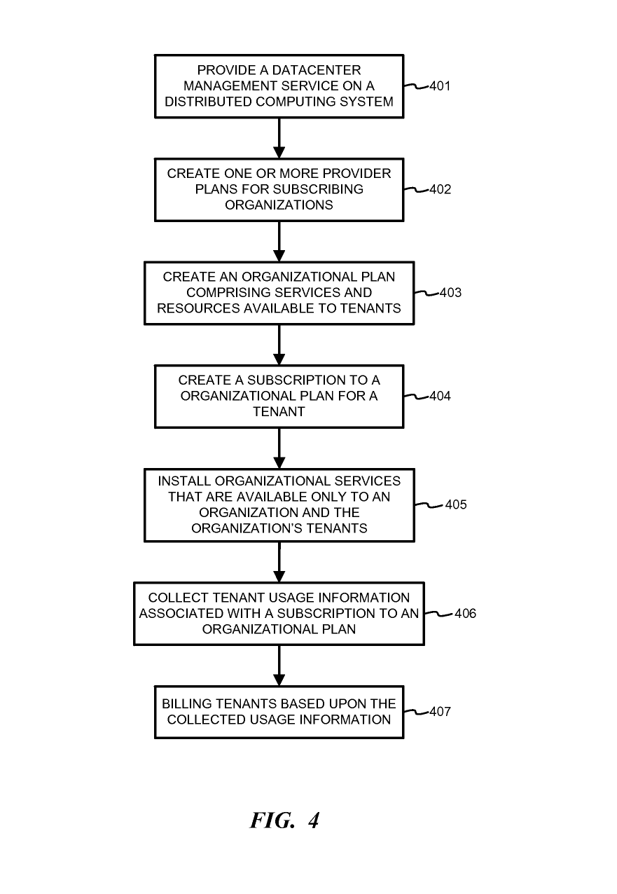

FIG. 4 is a flowchart illustrating a method of providing hierarchical subscription services in one embodiment. In step 401, a datacenter management service is provided on a distributed computing system. The distributed computing system may provide, for example, a public, private, or hybrid cloud service using servers located in one or more locations. The datacenter management service allows the provider of the distributed computing system, such as an administrator, to manage subscriptions and resources. In step 402, one or more provider plans are created for subscribing organizations. The provider plans allow the organizations to independently manage a subset of the distributed computing system by offering subscriptions and resources to datacenter tenants.

In step 403, the organization creates at least one organizational plan that comprises services and resources that are available by subscription to an organization's tenants. In step 404, the organization creates an organizational subscription for a tenant. The subscription provides a set of services and resources in a selected organizational plan.

In step 405, the organization may install one or more organizational services that are available only to an organization and the organization's tenants. In step 406, the datacenter organization collects usage information for tenant use associated with a subscription to a selected organizational plan. In step 407, the organization bills the tenants based upon the collected usage information.

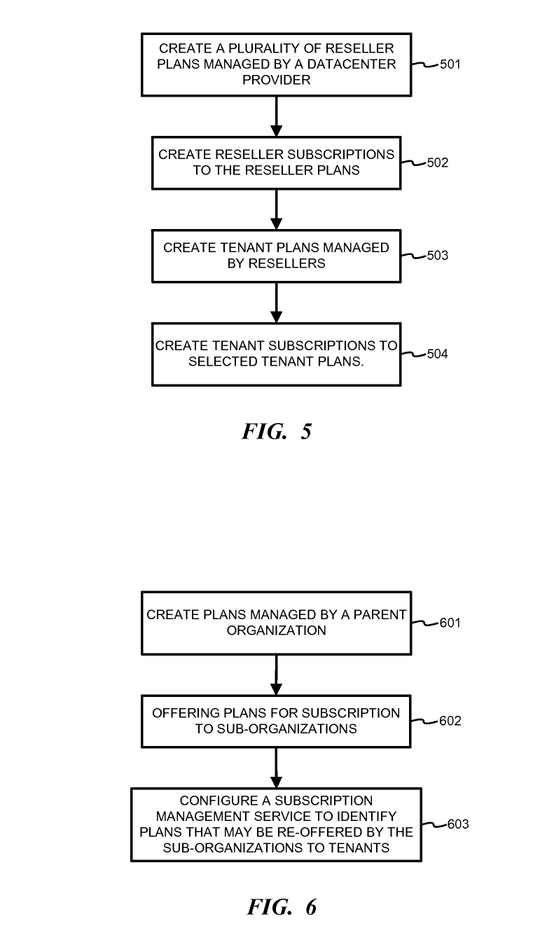

FIG. 5 is a flowchart illustrating a method for providing reseller plans according to one embodiment. In step 501, a plurality of reseller plans are created. The reseller plans are managed by a datacenter provider and comprise a group of services available for use and resale by resellers. In step 502, reseller subscriptions are created for selected reseller plans. In step 503, the resellers create a plurality of tenant plans that the resellers manage. The tenant plans comprise a group of services available for use by tenants. In step 504, tenant subscriptions are created for selected tenant plans.

FIG. 6 a flowchart illustrating a method for offering reseller plans according to one embodiment. In step 601, plans are created. The plans are managed by a parent organization and provide access to services offered on a distributed computing network. In step 602, the plans are offered for subscription by sub-organizations. In step 603, a subscription management service is configured to identify plans that are permitted to be re-offered by the sub-organizations to tenants of the sub-organizations.

A non-exclusive example of a computer-implemented method for managing subscriptions in a datacenter comprises providing a datacenter management service running on a distributed computing system. The datacenter management service allows a distributed computing system provider to manage subscriptions and resources. The method further comprise creating one or more provider plans for subscribing organizations to independently manage a subset of the distributed computing system by offering subscriptions and resources to datacenter tenants.

The method may include installing one or more organizational services that are available only to an organization and the organization's tenants. The method may include one or more of: creating at least one organizational plan comprising services and resources available by subscription to an organization's tenants, creating an organizational subscription for a tenant, the subscription providing a set of services and resources in a selected organizational plan, assigning a user interface theme to show to all of an organization's tenants, providing a gallery of datacenter services that are available to add to a selected organizational plan by a subscribing tenant.

The method may further include collecting tenant usage information associated with a subscription to a selected organizational plan, and billing tenants based upon the collected usage information.

The method may include one or more of: assigning Domain Name System (DNS) names selected by the organization to a portal providing a user experience to tenants, exposing a management API that provides organizations with programmatic access for managing the distributed computing system resources, providing a subscription management service to organizations and tenants, the subscription management service allowing organizations and tenants to register new services.

The method may further include installing a new service by an organization, registering a resource provider for the new service, and adding the new service to at least one of the organization's plans.

The method may further include registering the provider on the distributed computing system and, as a result of the registering, automatically subscribing the provider to a default set of services and resources define in a zero-day plan.

An example system for managing subscriptions in a datacenter comprises one or more processors and one or more computer-readable storage media having stored thereon computer-executable instructions that, when executed by the one or more processors, cause the processors to: create a plurality of reseller plans managed by a datacenter provider, the reseller plans comprising a group of services available for use and resale by resellers; create reseller subscriptions to selected reseller plans; create a plurality of tenant plans managed by the resellers, the tenant plans comprising a group of services available for use by tenants; and create tenant subscriptions to selected tenant plans.

The system may further include computer-executable instructions that, when executed by the one or more processors, cause the processors to: provide a datacenter management service running on the one or more processors, the datacenter management service allowing the provider to manage subscriptions and resources.

The system may further include computer-executable instructions that, when executed by the one or more processors, cause the processors to: register the datacenter provider on a distributed computing system and, as a result of the registering, automatically subscribe the provider to a default set of services and resources define in a zero-day plan.

The system may further include computer-executable instructions that, when executed by the one or more processors, cause the processors to: install one or more reseller services that are available only to a reseller and subscribers of the reseller's tenant plans.

The system may further include computer-executable instructions that, when executed by the one or more processors, cause the processors to: collect tenant usage information associated with a subscription to a selected tenant plan; and bill tenants based upon the collected usage information.

The system may further include computer-executable instructions that, when executed by the one or more processors, cause the processors to: assign Domain Name System (DNS) names selected by the organization to a portal providing a user experience to tenants; and expose a management API that provides organizations with programmatic access for managing the distributed computing system resources.

The system may further include computer-executable instructions that, when executed by the one or more processors, cause the processors to: provide a subscription management service to organizations and tenants, the subscription management service allowing organizations and tenants to register new services.

A non-limiting example of a computer-implemented method for creating subscription plans in a distributed computing network comprises creating a plurality of plans managed by a parent organization, the plans providing access to services offered on the distributed computing network, offering the plans for subscription by sub-organizations, and configuring a subscription management service to identify one or more of the plans that are permitted to be re-offered by the sub-organizations to tenants of the sub-organizations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
providing a datacenter management service running on a distributed computing system, the datacenter management service allowing a distributed computing system provider to manage subscriptions and resources;
creating one or more provider plans for subscribing organizations to independently manage a subset of the distributed computing system by offering subscriptions and resources to datacenter tenants.

2. The computer-implemented method of claim 1, further comprising:
installing one or more organizational services that are available only to an organization and the organization's tenants.

3. The computer-implemented method of claim 1, further comprising:
creating at least one organizational plan comprising services and resources available by subscription to an organization's tenants.

4. The computer-implemented method of claim 3, further comprising:
creating an organizational subscription for a tenant, the subscription providing a set of services and resources in a selected organizational plan.

5. The computer-implemented method of claim 3, further comprising:
assigning a user interface theme to show to all of an organization's tenants.

6. The computer-implemented method of clam 1, further comprising:
providing a gallery of datacenter services that are available to add to a selected organizational plan by a subscribing tenant.

7. The computer-implemented method of clam 1, further comprising:
collecting tenant usage information associated with a subscription to a selected organizational plan; and
billing tenants based upon the collected usage information.

8. The computer-implemented method of clam 1, further comprising:
assigning Domain Name System (DNS) names selected by the organization to a portal providing a user experience to tenants.

9. The computer-implemented method of clam 1, further comprising:
exposing a management API that provides organizations with programmatic access for managing the distributed computing system resources.

10. The computer-implemented method of claim 1, further comprising:
providing a subscription management service to organizations and tenants, the subscription management service allowing organizations and tenants to register new services.

11. The computer-implemented method of claim 10, further comprising:
installing a new service by an organization;
registering a resource provider for the new service; and
adding the new service to at least one of the organization's plans.

12. The computer-implemented method of claim 1, further comprising:
registering the provider on the distributed computing system; and
as a result of the registering, automatically subscribing the provider to a default set of services and resources define in a zero-day plan.

13. A system, comprising:
one or more processors;
one or more computer-readable storage media having stored thereon computer-executable instructions that, when executed by the one or more processors, cause the processors to:
create a plurality of reseller plans managed by a datacenter provider, the reseller plans comprising a group of services available for use and resale by resellers;
create reseller subscriptions to selected reseller plans;
create a plurality of tenant plans managed by the resellers, the tenant plans comprising a group of services available for use by tenants; and
create tenant subscriptions to selected tenant plans.

14. The system of claim 13, further comprising:
provide a datacenter management service running on the one or more processors, the datacenter management service allowing the provider to manage subscriptions and resources.

15. The system of claim 13, further comprising:
register the datacenter provider on a distributed computing system; and
as a result of the registering, automatically subscribe the provider to a default set of services and resources define in a zero-day plan.

16. The system of claim 13, further comprising:
install one or more reseller services that are available only to a reseller and subscribers of the reseller's tenant plans.

17. The system of clam 13, further comprising:
collect tenant usage information associated with a subscription to a selected tenant plan; and
bill tenants based upon the collected usage information.

18. The system of clam 13, further comprising:
assign Domain Name System (DNS) names selected by the organization to a portal providing a user experience to tenants; and
expose a management API that provides organizations with programmatic access for managing the distributed computing system resources.

19. The system of claim 13, further comprising:
provide a subscription management service to organizations and tenants, the subscription management service allowing organizations and tenants to register new services.

20. A computer-implemented method for creating subscription plans in a distributed computing network, comprising:
creating a plurality of plans managed by a parent organization, the plans providing access to services offered on the distributed computing network;
offering the plans for subscription by sub-organizations; and
configuring a subscription management service to identify one or more of the plans that are permitted to be re-offered by the sub-organizations to tenants of the sub-organizations.
